(19) United States
(12) Patent Application Publication
(10) Pub. No.: US 2014/0284508 A1
(43) Pub. Date: Sep. 25, 2014

(54) Venturi Valve with Hard Stop

(71) Applicant: E.H. Price Ltd., Winnipeg (CA)

(72) Inventors: Matthew James Roy Nesbitt, Winnipeg (CA); Jarvis Matthew Penner, Winnipeg (CA)

(73) Assignee: E.H. Price Ltd., Winnipeg (CA)

(21) Appl. No.: 13/972,502

(22) Filed: Aug. 21, 2013

Related U.S. Application Data
(60) Provisional application No. 61/804,906, filed on Mar. 25, 2013.

(51) Int. Cl. F16K 27/06

(52) U.S. Cl. CPC F16K 27/062
USPC 251/124

(57) ABSTRACT

A Venturi valve has a Venturi housing with a plunger slidably mounted on a control shaft within the Venturi housing. Sliding movement of the plunger along the control shaft is controlled by a compression spring. A hard stop is fixed to the control shaft to limit the movement of the plunger along the control shaft in order to keep the compression spring from over compression and from a resulting loss of accuracy.

### CROSS REFERENCE TO RELATED PATENT APPLICATIONS

This patent application claims priority from U.S. Provisional Patent Application No. 61/804,906, filed Mar. 25, 2013, which is hereby incorporated by reference.

### FIELD OF THE INVENTION

This invention relates to a Venturi valve, and more particularly relates to a spring-loaded plunger for the Venturi valve that controls the flow of air through the Venturi valve.

### BACKGROUND OF THE INVENTION

Venturi valves are pressure independent flow control valves, suitable for health care and laboratory spaces that require accurate room pressurization and proper directional air flow. The valve assembly consists of a Venturi shaped outer housing and an internal plunger assembly. The plunger assembly maintains constant air flow through the valve at a given set-point or actuator position regardless of changes in static duct pressure.

A conventional Venturi valve 10 is shown in FIG. 1. The conventional Venturi valve 10 comprises a Venturi shaped outer housing 12 with an inlet 11, an outlet 13, and an internal plunger assembly 14. The plunger assembly 14 comprises a sliding control shaft mounted on slide bearings 18 and 20. A control arm 24 controls the sliding movement and position of the control shaft 16. A piston 22 is fixed to the control shaft 16 for movement with the control shaft 16. A plunger 26 is slidably mounted on the control shaft. The plunger 26 comprises a plunger body 28 attached to a plunger cylinder 30 having an end cap 32. The plunger cylinder 30 is free to slide over the fixed piston 22, and the end cap 32 is free to slide along the control shaft 16. An engineered, multi-rate compression spring 34 is positioned between the fixed piston 22 and the end cap 32 to control the sliding movement of the plunger 26 along the control shaft 16.

The control arm 24 is driven by a controller (not shown) in response to HVAC system conditions and parameters. The control arm establishes a longitudinal set position or set point for the control shaft 16 of the Venturi valve 10. The set point is established with respect to the operating conditions required for the Venturi valve 10 in a particular HVAC system. After the longitudinal position of the control shaft 16 is set and as duct static pressure fluctuates, the engineered, multi-rate spring 34 inside the plunger 26 controls the movement of the plunger 26 back and forth along the control shaft 16. Movement of the plunger 26 to the left in FIG. 1 against the multi-rate spring 34 and in response to increased air pressure at the inlet 11 causes the plunger 26 to reduce the size of the opening through the Venturi valve 10. Movement of the plunger 26 to the right in FIG. 1 at the urging of the multi-rate spring 34 and in response to decreased air pressure at the inlet 11 causes the plunger 26 to reduce the size of the opening through the Venturi valve 10. Therefore, the movement of the plunger 26 along the control shaft 16 either reduces or expands the opening through the Venturi valve 10, thereby maintaining constant flow across the Venturi valve 10 and out of the outlet 13 in the direction shown by the arrow in FIG. 1.

The spring 34 is an engineered, multi-rate spring with a particularly designed force curve. The plunger 26 of the Venturi valve 10 operates along that designed force curve of the spring 34 to ensure constant air flow through the Venturi valve 10. Under normal operating conditions, the Venturi valve spring 34 maintains an accurate level of constant air flow through the Venturi valve 10 as the plunger 26 follows the force curve of the spring 34 as designed. If the HVAC system fails and creates a pressure surge, the summation forces acting on the plunger 26 become greater than the forces experienced by the plunger 26 during normal operation. Under the circumstance of such a pressure spike, the spring 34 is over compressed, and the spring's force curve can instantaneously deteriorate. Over-compression of the spring 34 damages the spring 34, and such damage directly affects the force curve and therefore the accuracy of the operation of the plunger 26.

Engineered, multi-rate Venturi springs 34 are more susceptible to deterioration and loss of accuracy resulting from over compression because the multi-rate Venturi springs 34 use only a portion of the force curve. This means that at different loaded values on the spring 34, the force varies non-linearly. The multi-rate is achieved by a conical shape with varying pitch (the distance between each coil). During over-compression, the pitch becomes altered, and Venturi spring's force curve deteriorates rapidly. Once deterioration of the multi rate Venturi spring 34 has occurred, the spring 34 will no longer follow the designed force curve, meaning the spring will no longer respond as it did prior to the over-compression, and the Venturi valve 10 will lose accuracy.

Further, because spring design is a separate engineering discipline from HVAC design, a second party is usually employed to design and manufacture the Venturi springs 34 based on a force curve developed by the Venturi valve designer. Unless the Venturi valve designer tests to failure and discusses the spring issues with the spring designer, spring deterioration is unknown and therefore no failure preventative measures are included in the spring design.

### SUMMARY OF THE INVENTION

In order to solve the problem associated with the deterioration of multi-rate Venturi springs from over compression, a hard stop is positioned on the control shaft to engage the end cap of the plunger and thereby limit the extent of the travel of the plunger. Limiting the travel of the plunger keeps the Venturi spring from becoming over-compressed during extreme conditions (pressure surges outside of normal operating range), thereby assuring that the Venturi spring will maintain its designed force curve and thereby maintaining accurate control of the air flow through the Venturi valve.

Further objects, features and advantages will become apparent upon consideration of the following detailed description of the invention when taken in conjunction with the drawings and the appended claims.

### BRIEF DESCRIPTION OF THE DRAWINGS

FIG. 1 is a section view of a conventional Venturi valve in accordance with the prior art.

FIG. 2 is a section view of a Venturi valve with a hard stop in accordance with the present invention.

FIG. 3 is an enlarged section view of a Venturi valve with a hard stop in accordance with the present invention.

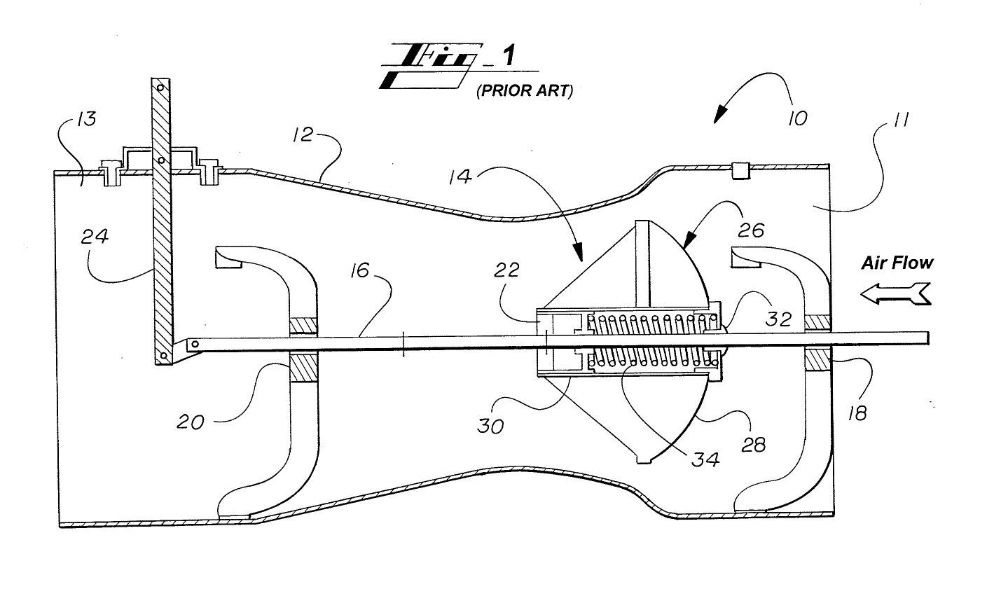

### DETAILED DESCRIPTION OF THE PREFERRED EMBODIMENT

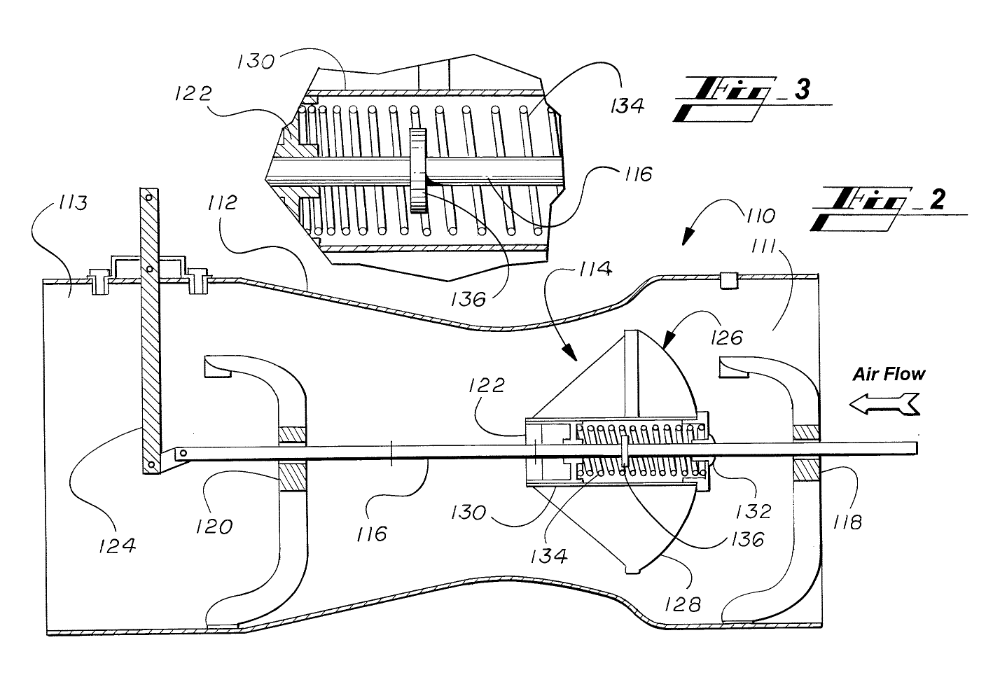

A Venturi valve 110 in accordance with the present invention is shown in FIGS. 2 and 3. The Venturi valve 110 comprises a Venturi shaped outer housing 112 with an inlet 11, an outlet 13, and an internal plunger assembly 114. The plunger assembly 114 comprises a sliding control shaft mounted on slide bearings 118 and 120. A control arm 124 controls the sliding movement and position of the control shaft 116. A piston 122 is fixed to the control shaft 116 for movement with the control shaft 116. A plunger 126 is slidably mounted on the control shaft. The plunger 126 comprises a plunger body 128 attached to a plunger cylinder 130 having an end cap 132. The plunger cylinder 130 is free to slide over the fixed piston 122, and the end cap 132 is free to slide along the control shaft 116. An engineered, multi-rate compression spring 134 is positioned between the fixed piston 122 and the end cap 132 to control the sliding movement of the plunger 126 along the control shaft 116. A hard stop 136 is fixed to the control shaft 116 at a position displaced from the piston 122.

In operation, the control arm 124 is driven by a controller (not shown) in response to HVAC system conditions and parameters. The control arm establishes a longitudinal set position or set point for the control shaft 116 of the Venturi valve 110. The set point is established with respect to the operating conditions required for the Venturi valve 110 in a particular HVAC system. After the longitudinal position of the control shaft 116 is set and as duct static pressure fluctuates, the engineered, multi-rate spring 134 inside the plunger 126 controls the movement of the plunger 126 back and forth along the control shaft 116. Movement of the plunger 126 to the left in FIG. 2 against the multi-rate spring 134 and in response to increased air pressure at the inlet 111 causes the plunger 126 to reduce the size of the opening through the Venturi valve 110. Movement of the plunger 126 to the right in FIG. 2 at the urging of the multi-rate spring 134 and in response to decreased air pressure at the inlet 111 causes the plunger 126 to reduce the size of the opening through the Venturi valve 110. Therefore, the movement of the plunger 126 along the control shaft 116 either reduces or expands the opening through the Venturi valve 110, thereby maintaining constant flow across the Venturi valve 110 and out of the outlet 113 in the direction shown by the arrow in FIG. 2.

As previously noted, spring 134 is an engineered, multi-rate spring with a particularly designed force curve. The plunger 126 of the Venturi valve 110 operates along that designed force curve of the spring 134 to ensure constant air flow through the Venturi valve 110. The designed force curve corresponds to the distance between the end cap 132 and the hard stop 136 when the spring 134 is uncompressed.

Under normal operating conditions, the Venturi valve spring 134 maintains an accurate level of constant air flow through the Venturi valve 110 as the end cap 132 of the plunger 126 follows the designed force curve of the spring 134 along the control shaft 116 from the uncompressed position of the spring 134 to the hard stop 136.

If the HVAC system fails and creates a pressure surge, the summation forces acting on the plunger 26 become greater than the forces experienced by the plunger 126 during normal operation. Under the circumstance of such a pressure spike, the plunger 126 is forced by the air flow toward the fixed piston 122 (to the left in FIG. 2). The movement of the plunger 126 toward the fixed piston 122, however, is arrested by the end cap 132 engaging the hard stop 136 thereby keeping the spring 134 from being over compressed. Once the pressure spike has subsided, the plunger 126 can return to its normal operation along the designed force curve defined by the distance between the end cap 132, when the spring 134 uncompressed, and the hard stop 136.

While this invention has been described with reference to preferred embodiments thereof, it is to be understood that variations and modifications can be affected within the spirit and scope of the invention as described herein and as described in the appended claims.

I claim:

1. A Venturi valve comprising:
a. a Venturi shaped housing having an inlet and a length;
b. a control shaft mounted within the housing and extending along the length of the housing;
c. a plunger slidably mounted on the control shaft within the housing;
d. a spring engaging the control shaft and the plunger wherein the spring controls relevant movement between the control shaft and the plunger in response to air pressure at the inlet; and
e. a hard stop fixed to the control shaft for limiting movement of the plunger along the control shaft and thereby limiting compression of the spring.

2. A Venturi valve comprising:
a. a Venturi shaped housing having an inlet and a length; and
b. a plunger assembly comprising:
i. a control shaft mounted within the housing and extending along the length of the housing with a fixed piston;
ii. a plunger with an end cap slidably mounted on the control shaft;
iii. a compression spring positioned between the fixed piston and the end cap for controlling the movement of the plunger along the control shaft in response to air pressure at the inlet; and
iv. a hard stop fixed to the control shaft at a position displaced from the fixed piston toward the end cap of the plunger.
